(19) United States
(12) Patent Application Publication
(10) Pub. No.: US 2026/0111022 A1
(43) Pub. Date: Apr. 23, 2026

(54) APPARATUS, METHOD OF CONTROLLING APPARATUS, AND STORAGE MEDIUM

(71) Applicant: CANON KABUSHIKI KAISHA, Tokyo (JP)

(72) Inventor: DAISUKE ISHII, Tokyo (JP)

(21) Appl. No.: 19/360,174

(22) Filed: Oct. 16, 2025

(30) Foreign Application Priority Data
Oct. 18, 2024 (JP) 2024-182575

(51) Int. Cl. G05B 23/02

(52) U.S. Cl. CPC G05B 23/0283; G05B 23/0264; G05B 23/0272

(57) ABSTRACT

An apparatus includes: one or more processors and/or circuitry which function as: a reception unit configured to receive an operation for activation; and an activation unit configured to perform activation in a first operation mode including a repair function being a function necessary for a diagnosis, a maintenance, and a repair, and a service function in a case where the operation received by the reception unit is a first operation, and to perform activation in a second operation mode including the repair function included in the first operation mode in a case where the operation received by the reception unit is a second operation being different from the first operation.

### BACKGROUND

### Field of the Technology

The present disclosure relates to a failure diagnosis of an apparatus.

### Description of the Related Art

In a case of occurrence of a failure or an anomaly of an apparatus, a user inquires of a place of purchase or a manufacturer about a failure, and a failure diagnosis and a repair of the apparatus are carried out by a repair service provider. Japanese Patent Laid-Open No. 2002-092206 (hereinafter referred to as “Document 1”) discloses a failure diagnosis system configured to diagnose a state of operation of an apparatus from a remote location, to accumulate support cases, and to presume a cause of a failure based on the support cases.

According to the technique described in Document 1, efficiency of repairing the apparatus will be deteriorated in a case where it is not possible to conduct a remote diagnosis of the apparatus. There is a demand for technology that allows easy repair of the apparatus.

### SUMMARY

An apparatus according to the present disclosure, includes: one or more processors and/or circuitry which function as: a reception unit configured to receive an operation for activation; and an activation unit configured to perform activation in a first operation mode including a repair function being a function necessary for a diagnosis, a maintenance, and a repair, and a service function in a case where the operation received by the reception unit is a first operation, and to perform activation in a second operation mode including the repair function included in the first operation mode in a case where the operation received by the reception unit is a second operation being different from the first operation.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view of a printing apparatus.

FIG. 2 is a cross-sectional view of a main part of the printing apparatus.

FIG. 3 is a block diagram showing a control configuration of the printing apparatus.

FIG. 4 is a functional block diagram of software for the printing apparatus.

FIG. 5 is a diagram showing an example of a configuration of an operating panel of the printing apparatus.

FIG. 6 is a diagram showing an example of a mode configuration of the printing apparatus.

FIG. 7 is a diagram showing an example of a log-in screen to a mode of the printing apparatus.

FIG. 8 is a diagram showing an example of a use history of the printing apparatus.

FIG. 9 is a flowchart showing an example of mode activation processing of the printing apparatus.

### DESCRIPTION OF THE EMBODIMENTS

Hereinafter, embodiments of the present disclosure are described with reference to the accompanying drawings. The following embodiments do not limit the present disclosure, and not all the combinations of features described in the embodiments are essential to the solution of the present disclosure. The same components are described with the same reference numerals. The steps in the flowcharts are denoted by reference numerals starting with “S”. Relative layout, shapes, and the like of the components described in the following embodiments are mere examples and are not intended to limit the scope of the present disclosure only to those examples.

### First Embodiment

### <<Inkjet Printing Apparatus>>

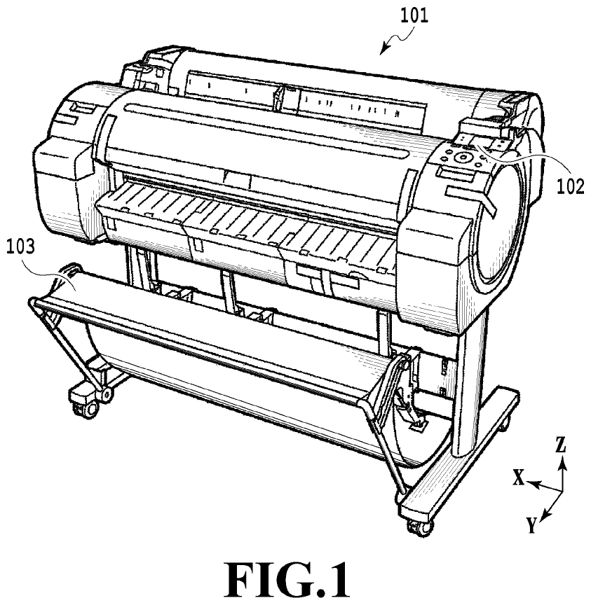

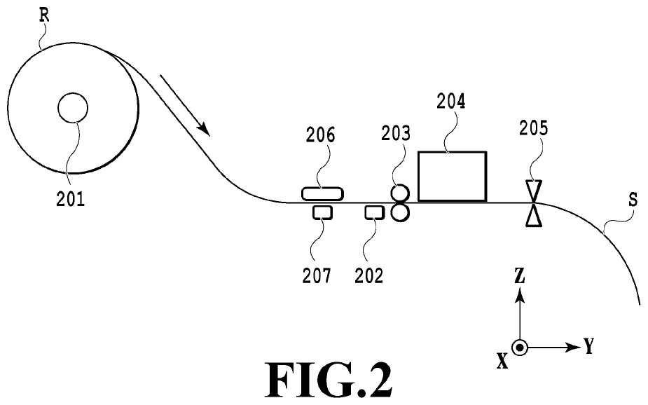

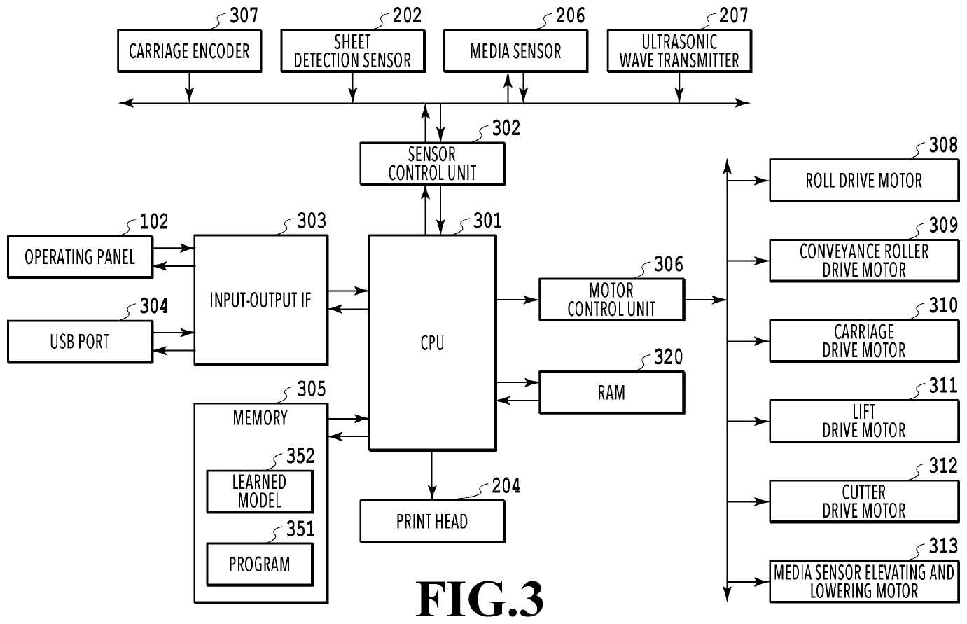

FIG. 1 is a perspective view of an ink jet printing apparatus presented as an example of a printing apparatus 101 in the preset embodiment, which executes industrial printing or commercial printing. FIG. 2 is a cross-sectional view of a main part of the printing apparatus 101. FIG. 3 is a block diagram showing a control configuration of the printing apparatus 101. A configuration of the printing apparatus 101 will be described below with reference to FIGS. 1 to 3. In the following description, a direction of conveyance in which a sheet S is conveyed in the printing apparatus 101 will be defined as +Y direction. A direction of ejection of inks from a print head 204 to the sheet S will be defined as −Z direction. A direction of movement of the print head 204 from a standby position will be defined as +X direction.

As shown in FIG. 2, the printing apparatus 101 rotatably holds a roll sheet R in which the sheet S is wound around in a rolled shape. The sheet S is supplied from the roll sheet R to conveyance rollers 203 by rotating the roll sheet R with a roll drive motor 308. The conveyance rollers 203 can rotate while pinching the sheet S in between. By rotating the conveyance rollers 203 with a conveyance roller drive motor 309, the sheet S is conveyed to a position where the print head 204 can perform printing on the sheet S. The print head 204 is mounted on a not-illustrated carriage and is configured to reciprocally move in the X direction. An image is printed on the sheet S by ejecting inks from the print head 204 to the conveyed sheet S while moving the print head 204 in the X direction. The sheet S with the image printed thereon is discharged from a discharge unit disposed downstream of the print head 204 in terms of the direction of conveyance, and is stacked on a basket 103 shown in FIG. 1.

An operating panel 102 is an interface module that receives various operations from a user. The user can perform various settings to the printing apparatus 101 by using various switches, a touch panel, and the like provided to the operating panel 102. Examples of the various settings to the printing apparatus 101 include setting of a size and a type of the sheet S, and the like. Meanwhile, a user interface screen (UI screen) may be displayed on the operating panel 102. The operating panel 102 is a reception unit (an input unit) that receives various operations from the user, and is also a display unit that displays the UI screen and the like. The use of the touch panel makes it possible to integrate the reception unit (the input unit) with the display unit.

A sheet detection sensor 202 is disposed upstream of the conveyance rollers 203 in the direction of conveyance. A conveyance operation of the sheet S is started in a case where the sheet detection sensor 202 detects the supply of the sheet S from the roll sheet R by the user. The conveyance operation of the sheet S is executed by driving the roll drive motor 308 synchronously with the conveyance roller drive motor 309.

A media sensor 206 and an ultrasonic wave transmitter 207 are disposed upstream of the sheet detection sensor 202 in the direction of conveyance. The media sensor 206 is located above in a direction of gravitational force (the Z direction) of the sheet S, and the ultrasonic wave transmitter 207 is located below in the direction of gravitational force of the sheet S. The media sensor 206 and the ultrasonic wave transmitter 207 are used for estimation of the sheet type.

The printing of an image on the sheet S is carried out as follows. First, the printing apparatus 101 executes a conveyance operation to convey the sheet S to a position opposed to the print head 204. Next, an image is printed in a region of the sheet S corresponding to the print head 204 by executing a printing operation to cause the print head 204 to scan in a direction of intersection that intersects (perpendicularly) with the direction of conveyance of the sheet S while ejecting the inks. Next, after conveyance of the sheet S in a predetermined amount, the inks are ejected while causing the print head 204 to scan in the direction of intersection. The desired image is printed on the sheet S by alternately executing the conveyance operation of the sheet S and the image printing operation as described above. The sheet S with the image printed thereon is sequentially conveyed downstream of the print head 204 in the direction of conveyance. The conveyed sheet S is cut out with a cutter 205 provided at the discharge unit. The sheet S thus cut out is stacked on the basket 103.

FIG. 3 is a block diagram showing an example of a configuration of a control system of the printing apparatus 101. The printing apparatus 101 includes the operating panel 102, the print head 204, a CPU 301, a sensor control unit 302, an input output interface (IF) 303, a USB port 304, a memory 305, a motor control unit 306, and a RAM 320. Moreover, the printing apparatus 101 includes the sheet detection sensor 202, the media sensor 206, the ultrasonic wave transmitter 207, and a carriage encoder 307. In addition, the printing apparatus 101 includes the roll drive motor 308, the conveyance roller drive motor 309, a carriage drive motor 310, a lift drive motor 311, a cutter drive motor 312, and a media sensor elevating and lowering motor 313. A program 351 and a learned model 352 are stored in the memory 305.

The motor control unit 306 controls the respective drive motors in accordance with the program 351 stored in the memory 305. The conveyance roller drive motor 309 rotates the conveyance rollers 203. The roll drive motor 308 rotates a spool 201. The conveyance roller drive motor 309 is provided with an encoder to detect an amount of revolutions for detecting an amount of conveyance of the sheet S. The carriage drive motor 310 can move the not-illustrated carriage and the print head 204 mounted on the carriage by rotating a not-illustrated carriage belt. The lift drive motor 311 vertically moves the carriage and the print head 204. The cutter drive motor 312 drives the cutter. The media sensor elevating and lowering motor 313 elevates and lowers the media sensor 206.

A variety of setting information and the like based on a user operation from a host PC connected either to the operating panel 102 or to the USB port 304 is inputted to the CPU 301 through the input-output IF 303. The inputted information is saved in the memory 305. The CPU 301 can read out the information saved in the memory 305 as appropriate, and subject the read information to a variety of processing. That is, the CPU 301 includes a processing unit which executes the variety of processing. The CPU 301 controls the carriage encoder 307, the sheet detection sensor 202, the media sensor 206, and the ultrasonic wave transmitter 207 through the sensor control unit 302, and obtains information therefrom. Meanwhile, the CPU 301 executes a variety of control based on input from the carriage encoder 307, the sheet detection sensor 202, and the media sensor 206. The RAM 320 is used as a temporary work area.

### <<Functional Blocks of Software>>

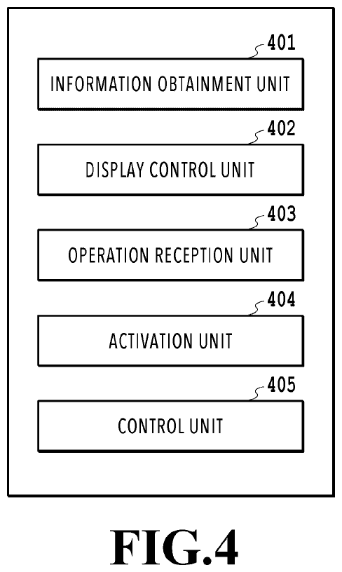

FIG. 4 is a functional block diagram of software for the printing apparatus 101. The CPU 301 loads the program 351 stored in the memory 305 into the RAM 320 and executes the loaded program, thereby realizing the following functional blocks of the software. The functional blocks of the software include an information obtainment unit 401, a display control unit 402, an operation reception unit 403, an activation unit 404, and a control unit 405.

The information obtainment unit 401 obtains information such as a presumed cause of a failure and a repair method by using the learned model stored in the memory 305. Meanwhile, the information obtainment unit 401 obtains sensor information and motor control information through the sensor control unit 302 or the motor control unit 306. Alternatively, the information obtainment unit 401 obtains the sensor information and the motor control information from the memory 305. In a case where the printing apparatus 101 is activated in a repair mode to be described later, information concerning the repair is properly obtained by the information obtainment unit 401. Accordingly, the printing apparatus 101 can provide the user with the information concerning the repair.

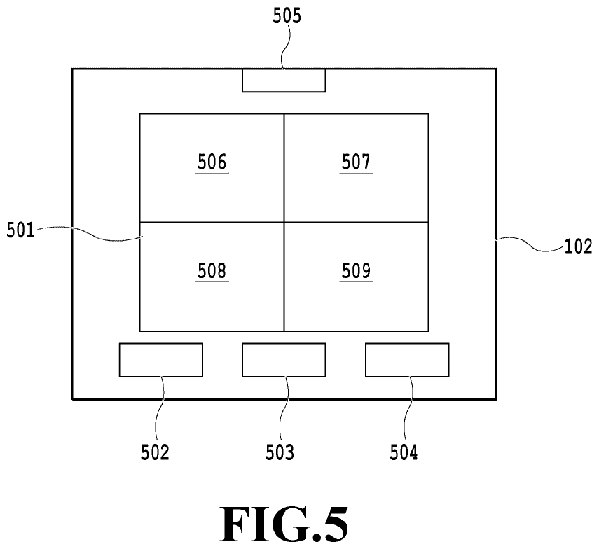

The display control unit 402 displays a screen such as the UI screen on the operating panel 102 by controlling an operation of the operating panel 102. The operation reception unit 403 receives input from the user to the UI screen displayed on the operating panel 102. The activation unit 404 activates the printing apparatus 101 in an operation mode based on an activation instruction from the user to the UI screen. The control unit 405 controls overall operations of the printing apparatus 101. For example, the printing apparatus 101 has two or more operation modes. A configuration example of the operation modes of the printing apparatus 101 is shown in FIG. 5. The control unit 405 controls the printing apparatus 101 in such a way as to be operated in the operation mode designated based on the activation instruction from the user to the UI screen displayed on the operating panel 102.

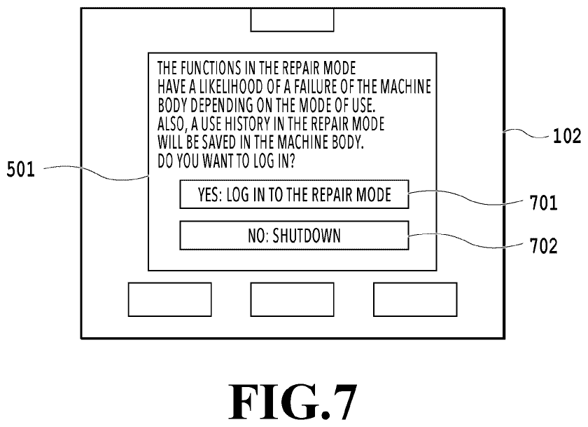

FIG. 5 is a diagram showing an example of the UI screen displayed on the operating panel 102 of the printing apparatus 101. A screen display unit 501 displays a menu screen of the printing apparatus 101 and information such as an operation status thereof. The display is started in a case where the printing apparatus 101 is powered on, and display contents depending on the operation status are displayed on the screen display unit 501. The screen display unit 501 is formed from a touch panel, and performs the display while changing a display area depending on the display contents. For example, regions 506, 507, 508, and 509 represent a display example of dividing the screen display unit 501 into 4 parts. Meanwhile, regions 701 and 702 shown in FIG. 7 represent a display example in which two specific regions on the screen display unit 501 have functions as a touch panel. The printing apparatus 101 performs processing in accordance with the contents of the pressed region.

Switches 502, 503, and 504 are disposed outside the screen display unit 501, and the printing apparatus 101 performs the processing in accordance with the type of the pressed switch. For example, the switch 502 is a power switch. By long pressing the switch 502, and the printing apparatus 101 performs activation processing to power on and carry out start-up, or termination processing to power off. Processing to convey the sheet S is carried out while the switch 503 is pressed, for instance. For example, processing to display a screen for interruption of the processing on the screen display unit 501 is carried out by pressing the switch 504 in a case where the printing apparatus 101 is carrying out certain processing. The method of dividing the regions of the screen display unit 501 is not limited to the above-mentioned method, and the screen display unit 501 may be formed from a touch panel divided into 9 parts or 16 parts, for example. Meanwhile, the number and locations to dispose the switches as well as the functions of the switches are not limited to the above-mentioned configurations. For instance, the switch may have the switch 504. Alternatively, in a case of a state after activation of the printing apparatus 101, a partial region of the screen display unit 501 may constantly display a touch panel as the switch 504, and the processing to display the screen for interruption of the processing on the screen display unit 501 may be carried out under the condition of pressing the switch 504.

A lamp 505 performs lighting depending on the status of operation of the printing apparatus 101. For example, white light is turned on during the activation processing of the printing apparatus 101 or during processing of a printing function. Green light is turned on in a steady state in which the printing apparatus 101 can accept processing. Red light is turned on in a case of displaying an error notification screen. Orange light is turned on in a case of displaying an alarm notification screen or in a case of displaying a screen to confirm intention of the user. The number and locations to dispose the lamps, colors of the lamps, and the lighting operation are not limited to the above-described configurations. For example, the lamp 505 may be turned on only the white light, and the lamp 505 may be turned on while changing an interval of blinking of the lamp 505 depending on the operation status of the printing apparatus 101.

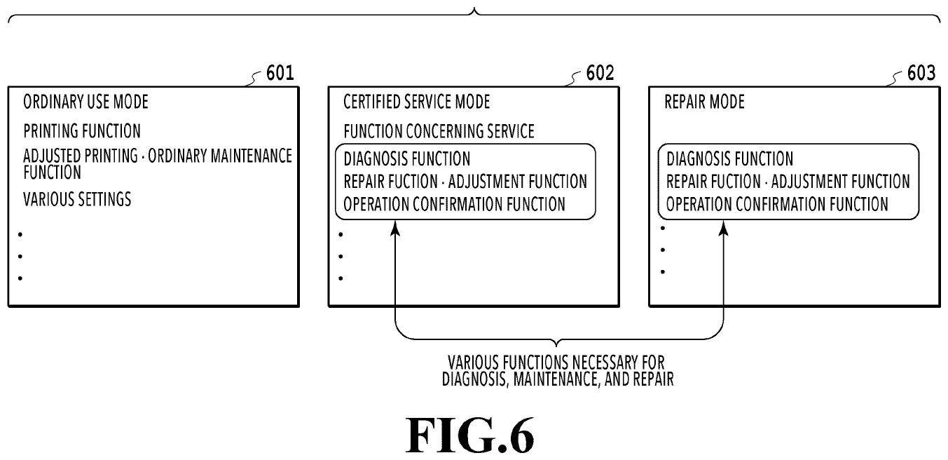

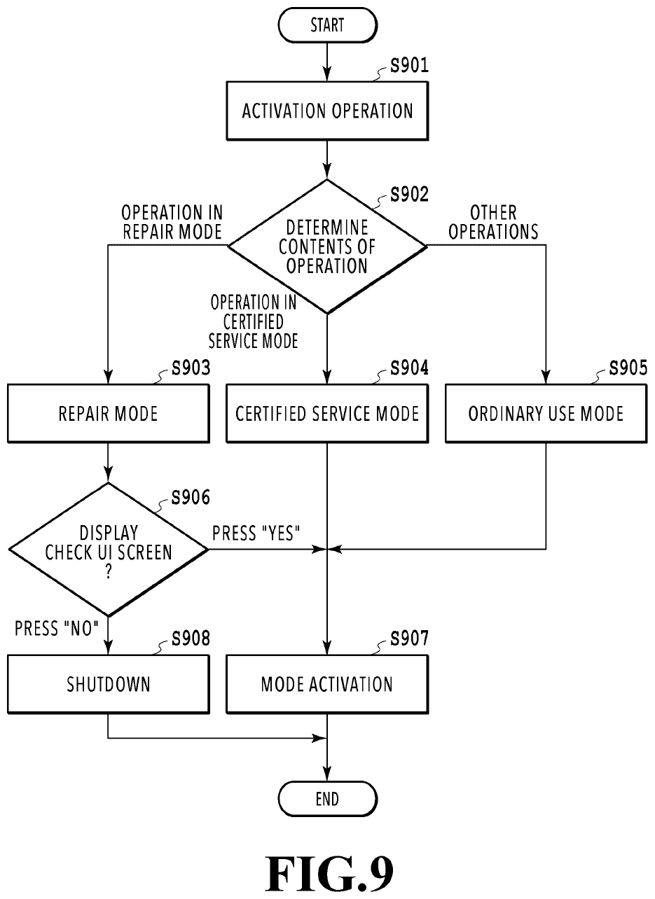

FIG. 6 is a diagram showing an example of an operation mode configuration of the printing apparatus 101. In a case of using the printing apparatus 101, the activation processing is carried out while designating one of the operation modes. FIG. 9 shows details of mode activation processing. The present embodiment describes the example of designating one of the operation modes in a case of using the printing apparatus 101. However, the present disclosure is not limited to this configuration. For example, a configuration to switch the operation mode by carrying out a specific operation in a state where the printing apparatus 101 is activated is also acceptable.

An ordinary use mode 601 is an operation mode for using the printing apparatus 101 for an ordinary use. In the ordinary use mode 601, the printing apparatus 101 is, for example, connected to a personal computer or a storage medium through the USB port 304 or a network, and a printing function is implemented in the printing apparatus 101 to print data in the personal computer or the storage medium thus connected. Meanwhile, in the ordinary use mode 601, adjusted printing such as a displacement adjustment function of the print head 204 or a cleaning function thereof, an ordinary maintenance function, and a consumable supply replacement function are also implemented in the printing apparatus 101. In addition, in the ordinary use mode 601, various setting functions including setting concerning the printing such as printing quality and a printing speed, an operation of the cutter against the sheet S, settings of monitor and notification of a residual amount of the sheet S, and the like are also implemented in the printing apparatus 101.

A certified service mode 602 is an operation mode for allowing a repair service provider to carry out a diagnosis, a repair, or a service operation. In the certified service mode 602, various functions which are necessary for the diagnosis, a maintenance, and the repair unable to use in the ordinary use mode 601 are implemented in the printing apparatus 101. For example, in the certified service mode 602, a diagnosis function for diagnosing a status of the printing apparatus 101, a repair function or an adjustment function for carrying out any of a repair and replacement of a component of the printing apparatus 101 or finely adjusting parameters, and an operation confirmation function are implemented in the printing apparatus 101. Since the repair or replacement of the component, or the parameter adjustment of the printing apparatus 101 is carried out in these functions, there may be a likelihood of affecting performances of the printing apparatus 101 or a likelihood of bringing about a failure of the printing apparatus 101 depending on a mode of use. Accordingly, the functions implemented in the certified service mode 602 are functions that are assumed to be used by the repair service provider with guaranteed knowledge and techniques concerning the repair of the printing apparatus 101. In the certified service mode 602, a function concerning a service (a service function) for operating a service by using the printing apparatus 101 is also implemented. An example of the function concerning the service is an administration function concerning a rental service configured to connect plural printing apparatuses 101 through a network. The contents of the service are not limited to this example. In the certified service mode 602, other contents of services may be implemented in the printing apparatus 101. Meanwhile, in the certified service mode 602, other functions which are neither the various functions necessary for the diagnosis, the maintenance, or the repair nor the function concerning the service may be implemented in the printing apparatus 101.

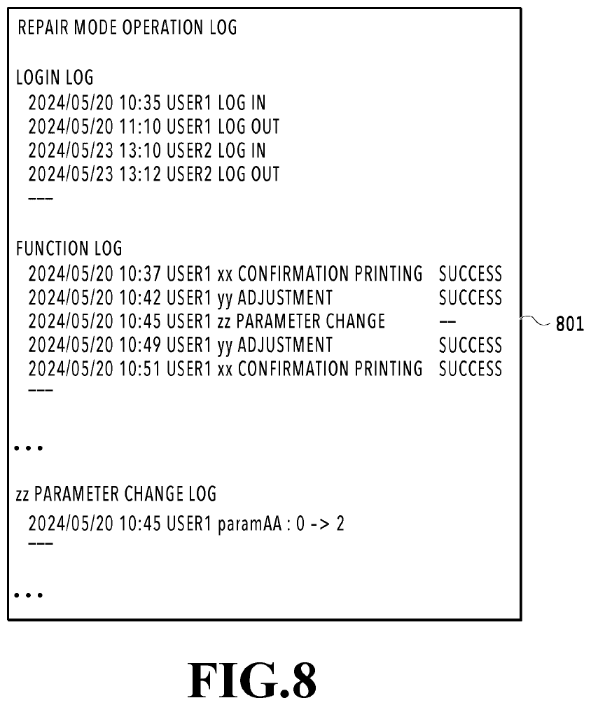

In a repair mode 603, functions equivalent to the various functions necessary for the diagnosis, the maintenance, or the repair in the certified service mode 602 are implemented in the printing apparatus 101. In the repair mode 603, the function concerning the service that is present in the certified service mode 602 is not implemented in the printing apparatus 101. The repair mode 603 is an operation mode for using the various functions necessary for the diagnosis, the maintenance, and the repair, which are assumed to be used by all users. As mentioned above, there may be the likelihood of affecting the performances of the printing apparatus 101 or the likelihood of bringing about a failure of the printing apparatus 101 depending on the mode of use. Accordingly, the likelihood concerning the repair mode 603 and an intention to save the use history are displayed on the screen display unit 501 of FIG. 7 before logging in to the repair mode 603. Details of the screen display unit 501 of FIG. 7 will be described in a section corresponding to FIG. 7. Meanwhile, details concerning the use history will be shown in FIG. 8, and the details of the mode activation processing will be described in a section corresponding to FIG. 9. In a case of using the repair mode 603, the use history in FIG. 8 is saved. The use history is used for analyzing a status of use of the repair function and contents of parameters, thus enabling improvement of efficiency in resolution in a case of occurrence of a problem in the printing apparatus 101, and enabling accumulation of information.

In the meantime, the use history may be saved in the ordinary use mode 601 and the certified service mode 602 as well. In this case, the contents of the use history and various conditions and timing for saving may vary depending on the operation mode. For example, a configuration of the use history in the ordinary use mode 601 includes a printing history, an execution history, an error history, an ink use history, and a setting history. In a case of printing, contents of operations are saved in the printing history. In a case of execution of a maintenance function such as an adjusted printing function, contents of maintenance are saved in the execution history. In a case of occurrence of an error, contents of the occurring error are saved in the error history. In a case of using an ink in the printing apparatus 101, an amount of use of the ink is saved in the ink use history. In a case of changing various main body settings and network settings of the printing apparatus 101, contents of change are saved in the setting history.

A configuration of the use history in the certified service mode 602 includes a component history representing the history of component information on the printing apparatus 101 and a repair history concerning the diagnosis, the maintenance, and the repair of the printing apparatus 101 in addition to the use history in the ordinary use mode 601. Update contents of the state of use of components, and update contents of information on replacement of the components are saved in the component history. In a case where the repair, adjustment, or the like of the component of the printing apparatus 101 is carried out, the contents of the diagnosis, the maintenance, and the repair of the printing apparatus 101 are saved in the repair history. More detailed contents than those of the use history in the ordinary use mode 601 are saved as the error history, the printing history, and the execution history of the maintenance function in the certified service mode 602. Meanwhile, a use history concerning the service may be saved in a service use history in the certified service mode 602.

In the meantime, a configuration of the use history in the repair mode 603 includes the component history and the repair history among the configuration of the use history in the certified service mode 602 in addition to the use history in the ordinary use mode 601. Here, the repair history in the repair mode 603 stores more detailed operation information as compared to the repair history in the certified service mode 602. Specifically, in the repair mode 603, repair information and adjustment information in which respective operations as well as an apparatus status of the printing apparatus 101 are expressed in chronological order are stored in the repair history in a more detailed fashion as compared to repair information and adjustment information in the certified service mode 602. A specific image of the repair information and the adjustment information is shown in FIG. 8. Meanwhile, the number of items of the repair history to be stored in the repair mode 603 may be larger than the number of items of the repair history in the certified service mode 602.

In the present embodiment, the printing apparatus 101 is configured to include the three types of operation modes, namely, the ordinary use mode 601, the certified service mode 602, and the repair mode 603. However, the present disclosure is not limited to this configuration. For instance, in addition to the above-mentioned three types of operation modes, the printing apparatus 101 may be provided with an operation mode to be used in a case of producing the printing apparatus 101.

FIG. 7 shows an example of a log-in screen to the repair mode 603 of the printing apparatus 101. In a case of logging in to the repair mode 603 at the time of the activation processing of the printing apparatus 101, the screen display unit 501 of FIG. 7 is displayed before logging in to the repair mode 603. The activation processing in the repair mode 603 is started in a case where the region 701 is pressed. Termination processing is started in a case where the region 702 is pressed, and the printing apparatus 101 is powered off. Details of the mode activation processing will be described in the section corresponding to FIG. 9.

FIG. 8 shows an example of the use history of the printing apparatus 101. In the present embodiment, a repair mode operation log 801 will be described as an example. A section “LOGIN LOG” represents a log that describes dates and times of activation or termination of the repair mode 603, and user names. A section “FUNCTION LOG” represents a log that describes dates and times of use of the various functions necessary for the diagnosis, the maintenance, or the repair, user names, and success or failure of operations. A section “ZZ PARAMETER CHANGE LOG” represents a log that describes dates and times of change of a parameter ZZ, which is changeable by parameter change functions of the various functions necessary for the diagnosis, the maintenance, and the repair, user names, and values before and after the change of the parameter ZZ. Contents, formats, data formats, and the like to be saved in the use history are not limited to the above-described configurations. For example, the contents of the repair mode operation log 801 may include the use history of contents of respective parameters for a predetermined period or in a case of using a specific function. Alternatively, the contents of the repair mode operation log 801 may include the use history of statuses of the respective components and the respective sensors for a predetermined period or in a case of using a specific function. Meanwhile, the use history may be saved as separate files depending on the respective contents to be saved, or the use history may be saved while defining the data format of the log as a binary file of a specific cipher format. In the meantime, as a method of referring to the use history, any of the operation modes of the printing apparatus 101 may include a function to print the contents of the use history or a function to transmit the use history. For example, the certified service mode 602 includes a function to print the contents of the repair mode operation log 801. By allowing the repair service provider to use the printed contents of the repair mode operation log 801 as one of information sources, it is possible to improve accuracy and efficiency of a causal analysis in a case of a failure of the printing apparatus 101 or in a case of occurrence of other problems.

FIG. 9 is a flowchart showing an example of the mode activation processing of the printing apparatus 101. In S901, the activation operation of the printing apparatus 101 is executed in the power-off state of the printing apparatus 101 or in a sleep state thereof. The activation operation is carried out by long-pressing the switch 502 in the power-off state of the printing apparatus 101, for example. Alternatively, an operation to press a combination of any of the switches 502, 503, and 504 with any of the regions 506, 507, 508, and 509 or an operation to sequentially press the switches and the like is carried out. For example, this is an operation to long-press the switch 502 in the state of pressing the region 506 and the switch 503. In the meantime, an operation to press only a certain location out of the touch panel regions of the screen display unit 501 is, for example, carried out in the sleep state of the printing apparatus 101. Alternatively, an operation to press only the switch 502 is carried out. Configurations used in the activation operation are not limited to these configurations, and the activation operation may include a different component of the printing apparatus 101. For example, a valid or invalid state of a specific sensor of the printing apparatus 101 or an inserted or extracted state of a power cable may be included in the combination in the activation operation or the sequence in the activation operation. Alternatively, connection or disconnection of a specific device to or from the USB port 304 may be included in the combination of the activation operation or the sequence in the activation operation.

In S902, the CPU 301 determines the contents of the activation operation in S901. The CPU 301 determines the type of the operation mode to be activated based on a result of determination. In a case where the switch 502 is long-pressed while pressing the region 508, for example, the CPU 301 determines that this is the activation operation in the repair mode 603, and the processing proceeds to S903. In a case where the switch 502 is long-pressed after pressing the switch 503 three times in the state of pressing the regions 506 and 507, the CPU 301 determines that this is the activation operation in the certified service mode 602, and the processing proceeds to S904. In a case where the switch 502 is long-pressed after carrying out an operation under other conditions, the CPU 301 determines that this is the activation operation in the ordinary use mode 601, and the processing proceeds to S905. The method in S902 of determining the contents of the activation operation in S901 is not limited to the above-described configurations. For example, in a case where the switch 502 is long-pressed while pressing the region 509 in the power-off state of the printing apparatus 101, the CPU 301 may determine that this is the activation operation in the repair mode 603, and the processing may proceed to S903. The processing may proceed to S903 in a case where a certain activation operation is carried out in the sleep state of the printing apparatus 101 in the repair mode 603. Alternatively, the processing may proceed to S904 in a case where a certain activation operation is carried out in the sleep state of the printing apparatus 101 in the certified service mode 602.

In S903, the CPU 301 determines the repair mode 603 as the operation mode to be activated, and the processing proceeds to S906. In S904, the CPU 301 determines the certified service mode 602 as the operation mode to be activated, and the processing proceeds to S907. In S905, the CPU 301 determines the ordinary use mode 601 as the operation mode to be activated, and the processing proceeds to S907.

In S906, the CPU 301 displays a confirmation UI screen through the display control unit 402. As mentioned earlier, the repair mode 603 is the operation mode assumed to be used by all users. The user needs to be notified of the likelihood of affecting the performances of the printing apparatus 101 or the likelihood of bringing about a failure of the printing apparatus 101 depending on the mode of use, and the like. Accordingly, the above likelihood concerning the repair mode 603 and the intention to save the use history are displayed on the screen display unit 501 of FIG. 7 as the confirmation UI screen in S906. The user presses the region 701 of FIG. 7 in a case of approval of the above confirmation items. Thus, the CPU 301 determines activation of the repair mode 603 and the processing proceeds to S907. The user presses the region 702 of FIG. 7 in a case of disapproval of the above confirmation items. Thus, the CPU 301 determines termination of the printing apparatus 101 without activation and the processing proceeds to S908. Although the confirmation UI screen has been described above as an example, the screen to be displayed may be a screen to notify of the above confirmation items. In this case, the CPU 301 determines approval of the confirmation items in a case where the switch 503 is pressed for example and determines disapproval of the confirmation items in a case where the switch 504 is pressed.

In S907, the CPU 301 obtains a variety of information through the information obtainment unit 401, and executes the activation processing of the printing apparatus 101 by controlling the printing apparatus 101 in the operation mode to be activated through the control unit 405. In a case where the operation mode to be activated is the repair mode 603, the information obtainment unit 401 properly obtains information concerning the repair at the time of activation of the printing apparatus 101. Accordingly, the printing apparatus 101 can provide the user with the information concerning the repair. In a case where the operation mode to be activated is the repair mode 603, the date, the time, and the user name at the point of activation are saved in the repair mode operation log 801 at the time of completion of the activation processing. The contents to be saved in the repair mode operation log 801 are not limited to the above contents. For example, respective parameters settable to the printing apparatus 101, statuses of the sensors, and error information as well as alarm information at the time of completion of the activation processing may also be saved. In S908, the CPU 301 aborts activation of the printing apparatus 101, and carries out termination processing (shutdown processing) of the printing apparatus 101. Upon completion of the termination processing (the shutdown processing), the printing apparatus 101 is powered off and the processing of the flowchart shown in FIG. 9 is terminated.

As described above, in the present embodiment, the certified service mode 602 and the repair mode 603 are implemented as the repair function of the printing apparatus 101. The certified service mode 602 is defined as the operation mode for the repair service provider while the repair mode 603 is defined as the operation mode for all users. The certified service mode 602 and the repair mode 603 implement the same repair functions, and change the functions of the operation mode and the contents of the use history to be saved depending on the operator. For example, the certified service mode 602 implements the function concerning the service (the service function). On the other hand, the repair mode 603 does not implement unnecessary functions, and saves more detailed contents of the use history in a case of using the repair mode as described in the repair mode operation log 801, for example, as compared to the use history in the certified service mode 602. Accordingly, it is possible to conduct a causal research and a countermeasure efficiently in the occurrence of a failure in the printing apparatus in a case where the repair mode is used not only by the repair service provider or a trained user but also by an untrained user. Accordingly, according to the technique of the present disclosure, the apparatus can be repaired easily.

### Other Embodiments

The apparatus that can adopt the present disclosure is not limited to the above-described printing apparatus. General apparatuses are targeted for the present disclosure. For example, apparatuses including a scanner apparatus, a copier, a facsimile apparatus, a multifunction apparatus, a portable terminal, a tablet terminal, a personal digital assistance (PDA), a smartphone, and the like are targeted for the present disclosure. In addition, apparatuses including a personal computer (PC) a laptop PC, a digital camera, a music player device, a television, a smart speaker, a head-mounted display (HMD), and the like are also targeted for the present disclosure.

The present disclosure can also be implemented through processing including supplying a program for implementing one or more functions of the embodiments described above to a system or an apparatus by using a network or a storage medium, and reading and executing, by a computer of the system or the apparatus, the program. The computer includes one or a plurality of processors or circuits, and may include a network of a plurality of individual computers or a plurality of individual processors or circuits, to read and execute a computer-readable instruction.

The processor or circuit may include a central processing unit (CPU), a micro processing unit (MPU), a graphics processing unit (GPU), an application specific integrated circuit (ASIC), or a field-programmable gate array (FPGA). Moreover, the processor or circuit can include a digital signal processor (DSP), a data flow processor (DFP), or a neural processing unit (NPU).

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-182575, filed Oct. 18, 2024, which is hereby incorporated by reference herein in its entirety.

What is claimed is:

1. An apparatus comprising:
one or more processors and/or circuitry which function as:
a reception unit configured to receive an operation for activation; and
an activation unit configured to perform activation in a first operation mode including a repair function being a function necessary for a diagnosis, a maintenance, and a repair, and a service function in a case where the operation received by the reception unit is a first operation, and to perform activation in a second operation mode including the repair function included in the first operation mode in a case where the operation received by the reception unit is a second operation being different from the first operation.

2. The apparatus according to claim 1, further comprising:
a display control unit configured to cause a display unit to display a screen configured to notify of activation in the second operation mode before performing activation in the second operation mode in a case where the acceptance unit accepts the second operation.

3. The apparatus according to claim 2, wherein the activation unit performs activation in the second operation mode in a case where an instruction to perform activation in the second operation mode is accepted after display of the screen.

4. The apparatus according to claim 2, wherein the activation unit aborts activation in a case where an instruction to perform activation in the second operation mode is not accepted after display of the screen.

5. The apparatus according to claim 1, wherein the repair function includes saving of a repair history in each operation mode.

6. The apparatus according to claim 5, wherein a quantity of items of the repair history to be saved in the second operation mode is larger than a quantity of items of the repair history to be stored in the first operation mode.

7. The apparatus according to claim 2, wherein the activation unit performs activation in a third operation mode being an ordinary use mode in a case where the operation accepted by the acceptance unit is a third operation being different from the first operation and the second operation.

8. The apparatus according to claim 7, wherein the display control unit performs activation without causing the display unit to display the screen in a case of activation in the first operation mode and in the third operation mode.

9. A method of controlling an apparatus, comprising:
receiving an operation for activation; and
performing activation in a first operation mode including a repair function being a function necessary for a diagnosis, a maintenance, and a repair, and a service function in a case where the operation received in the receiving is a first operation, and performing activation in a second operation mode including the repair function included in the first operation mode in a case where the operation received in the receiving is a second operation being different from the first operation.

10. A non-transitory computer readable storage medium storing a program which causes a computer to execute a method of controlling an apparatus, the method comprising:
receiving an operation for activation; and
performing activation in a first operation mode including a repair function being a function necessary for a diagnosis, a maintenance, and a repair, and a service function in a case where the operation received in the receiving is a first operation, and performing activation in a second operation mode including the repair function included in the first operation mode in a case where the operation received in the receiving is a second operation being different from the first operation.
